(19) United States
(12) Patent Application Publication
(10) Pub. No.: US 2020/0351761 A1
(43) Pub. Date: Nov. 5, 2020

(54) SYSTEM AND METHOD FOR MONITORING MOBILE DATA CONFIGURATION ACCESS POINT NAMES

(71) Applicant: Jose Luis HORNA, Doral, FL (US)

(72) Inventor: Jose Luis HORNA, Doral, FL (US)

(21) Appl. No.: 16/402,427

(22) Filed: May 3, 2019

(51) Int. Cl. H04W 48/16; H04W 8/00; H04W 8/26; H04W 48/02; H04W 24/08; H04W 8/18; H04W 4/60

(52) U.S. Cl. CPC H04W 48/16; H04W 8/005; H04W 8/26; H04W 4/60; H04W 24/08; H04W 8/183; H04W 48/02

(57) ABSTRACT

A system and method for monitoring mobile data configuration access point names, having the steps of: Starting up a User Equipment; evaluating a Network Rejection Event supported by the User Equipment; setting up the Network Rejection Event; setting up a timer event; waiting for events; waving the rejection event initiated; evaluating the Network Rejection Event; setting up the Network Rejection Event if the answer is no; opening the OPEN_CHANNEL data connection with a stored the APN_SERVICE on the SIM/eSIM if the answer is no; evaluating the Rejecting error; opening the OPEN_CHANNEL data connection with the DEFAULT_APN if the answer is no; evaluating the Network Rejection Event; sending a message to the management server if the answer is no; and setting up the Network Rejection Event.

### BACKGROUND OF THE INVENTION

### 1. Field of the Invention

The present invention relates to wireless telecommunications, and more particularly, to a system for a user equipment to periodically check connectivity with wireless data services.

### 2. Description of the Related Art

Wireless cellular communication is certainly one of the major evolutions provided to the telecommunication world. It experienced an exponential growth from the early 1990s, first based on so-called 1G (first-generation) analogue technologies like AMPS (Advanced Mobile Phone System) in the United States and NMT (Nordic Mobile Telephone) in Northern Europe. Those systems evolved to 2G (second-generation) digital radio, providing robustness and better spectral efficiency. In 2002, the first 3G networks on CDMA2000 1×EV-DO technology were launched by SK Telecom and KTF in South Korea. 4G/LTE came to the scenario with Telstra's 4G network introduced in October 2011, offering global mobility and improved end-user experience over a wide range of services. Ultimately, 5G still quite in its early stages, is likely to appear in the market by 2020 at the earliest. Goals for future 5G include significantly faster speeds (from 1 Gbps to 10 Gbps).

A common key point from 2.5G to 5G to grant connectivity is the access to predefined data gateways where charging and user access control is centralized. This standard scheme of connectivity is based on an APN concept, present in all mobile technologies based on package switching, like the Internet.

Applicant believes that one of the closest references corresponds to U.S. Pat. No. 9,699,716 B1 issued to Osterwise, et al. on Jul. 4, 2017 for Method and device for managing access point name information. However, it differs from the present invention because Osterwise, et al. teach a method and device for storing, in a UICC memory of a communication device, access point name information associated with a plurality of access point names to be selectively utilized by a device processor of the communication device for wireless communications, and providing the device processor with access to the access point name information in the UICC memory to enable the device processor to establish the wireless communications.

Applicant believes that another reference corresponds to U.S. Pat. No. 8,489,143 B1 issued to Olivier Dong on Jul. 16, 2013 for ME network parameters configuration by UICC. However, it differs from the present invention because Dong teaches a mobile device having a smart card. The smart card is programmed to generate a new configure command that can be used to configure network related parameters with in the mobile device. The configure command can be used to override existing network related parameters or to add additional network related parameters. The network related parameters may relate to different access points and an identifier may be associated with each set of network parameters to facilitate the subsequent identification of desired network related parameters.

Applicant believes that another reference corresponds to U.S. Pat. No. 9,154,929 B2 issued to Jean-Philippe Cormier on Oct. 6, 2015 for Transmission of the PDP context activation rejection cause codes to the UICC. However, it differs from the present invention because Cormier teaches a method and system for introducing support for SM rejections in a USAT network rejection event including an APN. The method and system provide the UICC with all PDP context activation rejection cause codes received by the ME and their respective APNs. Such a method and system allows the UICC to monitor all the rejections to intelligently select an appropriate APN to activate using its Open channel command.

Applicant believes that another reference corresponds to U.S. Pat. No. 9,282,532 B2 issued to Sen, et al. on Mar. 8, 2016 for Initiating bearer independent protocol sessions using access technology and location information. However, it differs from the present invention because Sen, et al. teach an user identity module (UIM) incorporated in an user equipment such as a mobile phone or mobile device. The UIM is configured to provision itself while roaming away from a home network as follows. The UIM may: send to the UE a request for information identifying a current radio access technology (RAT) that the UE is camped on; receive the current RAT information from the UE; send to the UE a request for network location information, where the network location information identifies a network in which the UE is currently camped; receive the network location information from the UE; generate an access point name (APN) using the current RAT information and the network location information; and open a channel through the network to a remote agent using the access point name.

Applicant believes that another reference corresponds to U.S. Pat. No. 9,408,071 B2 issued to Sanyal, et al. on Aug. 2, 2016 for System and method for APN correction in GTP messages associated with GPRS data services offered by mobile operator using a sponsor network. However, it differs from the present invention because Sanyal, et al. teach a method and system for APN (Access Point Name) correction in a GPRS data roaming scenario where a sponsor operator network is used, and a method and system for routing GTP messages to the correct destination network entity after actuating the APN correction as and when required. The GTP filter checks the IMSI and APN data in the GTP layer and, depending on the IMSI and APN data, performs APN correction and manipulates GTP parameters to ensure the PDP context is correctly established between the SGSN and the GGSN, and the further GTP Control or Data messages bypass the GTP Filter application. This solution allows appropriate routing of message, in particular for message to and from smartphone.

Applicant believes that another reference corresponds to U.S. Pat. No. 8,605,662 B2 issued to Shatzkamer, et al. on Dec. 10, 2013 for Intelligent real access point name (APN) selection using virtual APNS. However, it differs from the present invention because Shatzkamer, et al. teach a procedure where a first access request is received from a mobile device, the access request may be received through a first access medium for a virtual access point name (APN). A session is created with a service using a first real access point name (APN) for the mobile device. A second access request is received through a second type of access medium. The request may be received through a second virtual APN. A session is determined that is active for the mobile device through the first access medium and the second access request is assigned the first real APN even though the request is received through a second access medium. The continuity of the connection may then be maintained because the first real APN is still being used. In this case, a handoff of the connection from the first access network to the second access network is performed while the connection to the service is maintained through the first real APN.

Applicant believes that another reference corresponds to Non-Patent literature published on January, 2011 by 3th Generation Partnership Project (3GPP 31.111 V10.1.0) for Universal Subscriber Identity Module (USIM); Application Toolkit (USAT) (Release 10). However, it differs from the present invention because the Non-Patent literature published on January, 2011 by 3th Generation Partnership Project (3GPP 31.111 V10.1.0) for Universal Subscriber Identity Module (USIM); Application Toolkit (USAT) (Release 10) teaches an interface between the UICC and the Mobile Equipment (ME), and mandatory ME procedures, specifically for “USIM Application Toolkit”. This document refers in its majority to the ETSI TS 102 223 [32], which describes the generic aspects of application toolkits within the UICC.

Applicant believes that another reference corresponds to Non-Patent literature published in March 2017 by The European Telecommunications Standards Institute, (ETSI TS 102 223) for Smart Cards; Card Application Toolkit (CAT) (Release 14). However, it differs from the present invention because the Non-Patent literature published in March 2017 by The European Telecommunications Standards Institute, (ETSI TS 102 223) for Smart Cards; Card Application Toolkit (CAT) (Release 14) teaches the interface between the UICC and the terminal, and mandatory terminal procedures, specifically for “NAA Card Application Toolkit”. The Card Application Toolkit (CAT) is a set of generic commands and procedures for use by the ICC, irrespective of the access technology of the network. Within the scope of the present document, the UICC refers here to an ICC, which supports at least one application in order to access a network.

Applicant believes that another reference corresponds to Non-Patent literature published in May 2015 by SIMalliance for Interoperability Stepping Stones, (release 7). However, it differs from the present invention because the Non-Patent literature published in May 2015 by SIMalliance for Interoperability Stepping Stones, (release 7) teaches new cards that enable new user experience and new application model leading the UICC in the well known HTTP-based architecture.

Other patents describing the closest subject matter provide for a number of more or less complicated features that fail to solve the problem in an efficient and economical way. None of these patents suggest the novel features of the present invention.

### SUMMARY OF THE INVENTION

The present invention is a mechanism allowing a user identity module (UIM, SIM, eSIM, eUICC) that is incorporated/inserted/included in user equipment (UE) to periodically check connectivity with wireless data services provided by a access network were a subscriber is clamped, detecting if the UE has correctly setup the default APN record used by web browser or OTT providers.

The present invention is a system and method for monitoring mobile data configuration access point names, comprising the steps of:

A) triggering a packet data protocol context activation procedure or Public Data Network connectivity procedure in response to receiving, from a universal integrated circuit card, an Open Channel command with parameters that request a user equipment using a default APN;

B) receiving by the user equipment a terminal response evaluating received information and detecting an ACTIVATE packet data protocol CONTEXT REJECTION or Public Data Network CONNECTIVITY REJECTION message including a session management cause; and

C) triggering the packet data protocol context activation procedure or the Public Data Network connectivity procedure in response to receiving from the universal integrated circuit card, the Open Channel command with the parameters including specific APN profile.

The universal integrated circuit card monitors rejections related to data connection errors, and selects via an Open Channel command an APN profile that sets up as default on the user equipment, and the universal integrated circuit card monitors a result of the rejections related data connection errors. The terminal response is used to indicate to the universal integrated circuit card that there has been a problem with the Open Channel command. An Application server receives monitoring notifications including the rejections related data connection errors.

More specifically, the present invention is a system and method for monitoring mobile data configuration access point names, comprising the steps of:

A) Starting up a User Equipment, whereby a Mobile Equipment executes a start up process and the Mobile Equipment starts a communication exchange with a SIM/eSIM;

B) Evaluating a Network Rejection Event supported by the User Equipment, whereby the SIM/eSIM evaluates a TERMINAL_PROFILE capability of the Mobile Equipment in order to detect if the User Equipment supports the Network Rejection Event;

C) Setting up the Network Rejection Event, whereby if an answer is yes, the SIM/eSIM sends to the Mobile Equipment a first setup of the Network Rejection Event;

D) Setting up a timer event, whereby if the answer is no, the SIM/eSIM sends to the Mobile Equipment a second setup of a Timer using a defined T period; and

E) Waiting for events, whereby the SIM/eSIM waits for an occurrence of either the Network Rejection Event or a TIMER_EXPIRATION.

The system and method for monitoring mobile data configuration access point names further comprising the steps of:

F) Having the timer event, the Mobile Equipment sends to the SIM/eSIM a proactive command ENVELOPE_TIMER_EXPIRATION;

G) Opening a channel with a default APN, whereby the SIM/eSIM sends to the Mobile Equipment an OPEN_CHANNEL data connection using parameters defined as DEFAULT_APN;

H) Evaluating a Rejecting error, whereby the Mobile Equipment sends to the SIM/eSIM a result of the OPEN_CHANNEL data connection using the parameters defined as the DEFAULT_APN, and the SIM/eSIM evaluates if there is the Rejecting error;

I) Setting up the Timer if the answer is no, whereby after a successful the OPEN_CHANNEL data connection with the DEFAULT_APN, the SIM/eSIM requests to the Mobile Device to setup the TIMER with the defined T period;

J) Opening the channel with a stored the default APN on the SIM/eSIM if the answer is yes, whereby after an error is received as a result of the OPEN_CHANNEL data connection with the default APN, the SIM/eSIM sends to the Mobile Equipment the OPEN_CHANNEL data connection using the parameters defined as a APN_SERVICE;

K) Evaluating the Rejecting error, whereby the Mobile Equipment sends to the SIM/eSIM the result of the OPEN_CHANNEL data connection using the parameters defined by the APN_SERVICE, and the SIM/eSIM evaluates if there is an error;

L) Setting up the timer if the answer is no, whereby after a successful the OPEN_CHANNEL data connection with the APN_SERVICE; and

M) Sending a message to the management server if the answer is yes, whereby after an error is received as a result of the OPEN_CHANNEL data connection with the DEFAULT_APN, the SIM/eSIM detects that the Mobile Equipment has a faulty the DEFAULT_APN and initiates a process to inform a management server in order to take action to set up correctly the APN_SERVICE on the Mobile Device.

The system and method for monitoring mobile data configuration access point names further comprising the steps of:

N) Having the rejection event initated, the Mobile Equipment sends the SIM/eSIM a proactive command REJECTION_NETWORK with REJECTION code information, the SIM/eSIM disables the Network Rejection Event in order to avoid re-entrance during the rejection event;

O) Evaluating the Network Rejection Event, whereby the SIM/eSIM determines if the REJECTION code information is related to the OPEN_CHANNEL data connection in order to test an OPEN_CHANNEL procedure with and without the DEFAULT_APN;

P) Setting up the Network Rejection Event if the answer is no, whereby the SIM/eSIM sets up again the Network Rejection Event to the Mobile Equipment;

Q) Opening the OPEN_CHANNEL data connection with a stored the APN_SERVICE on the SIM/eSIM if the answer is no, whereby the SIM/eSIM sends to the Mobile Equipment the OPEN_CHANNEL data connection using the parameters defined as the APN_SERVICE;

R) Evaluating the Rejecting error, whereby the Mobile Equipment sends to the SIM/eSIM a result of the OPEN_CHANNEL data connection using the parameters defined as the APN_SERVICE, and the SIM/eSIM evaluates if there is an error;

S) Opening the OPEN_CHANNEL data connection with the DEFAULT_APN if the answer is no, whereby after a successful result of the OPEN_CHANNEL with an APN_SERVICE, the SIM/eSIM sends to the Mobile Equipment the OPEN_CHANNEL data connection using the parameters defined as the DEFAULT_APN;

T) Evaluating the Network Rejection Event, whereby after an error of the OPEN_CHANNEL data connection with the DEFAULT_APN the SIM/eSIM detects the Mobile Equipment having a faulty the DEFAULT_APN and initiates a process to inform the management server in order to take action to setup correctly the APN_SERVICE on the Mobile Device, and whereby if the answer is no, the SIM/eSIM sets up again the Network Rejection Event;

U) Sending a message to the management server if the answer is no, whereby the SIM/eSIM sets up again the REJECTION_NETWORK event to the Mobile Device; and

V) Setting up the Network Rejection Event, whereby the SIM/eSIM sets up again the REJECTION_NETWORK event to the Mobile Device.

It is therefore one of the main objects of the present invention to provide a system and method for monitoring mobile data configuration access point names.

It is another object of this invention to provide a method and system for evaluating and securing Internet connection.

It is another object of this invention to provide a method and system providing a mechanism allowing a user identity module (UIM, SIM, eSIM, eUICC) that is incorporated/inserted/included in user equipment (UE) to periodically check connectivity with wireless data services provided by a access network were a subscriber is clamped, detecting if the UE has correctly setup the default APN record used by web browser or OTT providers.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a prior art diagram illustrating different types of mobile networks classified by technology evolution or RAT. Topology showed are 2G-GPRS, 3G, and 4G/LTE networks to which a user mobile equipment item UE connects, and which is linked to external packet data networks, the different network elements are showed focused on the data services (like internet) access and details.

FIG. 2 is prior art illustration of a simplified, high-level function, block diagram of an exemplary mobile station.

FIG. 3 is a present invention diagram illustrating an embodiment of a system for a monitor mobile data configuration access point network (APN) utilizing a SIM of a wireless device showing signaling and connectivity between a User Equipment (UE) and various network elements depending on the RAT technology or network evolution.

FIG. 4 is a present invention illustration of one embodiment of a subscriber identity module (SIM/eSIM) that includes a processor, a memories RAM and ROM, an input/output module for connection management with the Mobile Equipment (ME) and the application with their internal APN information and configurations.

FIG. 5 is a flowchart of the present invention method during a startup communication between the Mobile Equipment (ME) and the subscriber identity module (SIM/eSIM).

FIG. 6 is a flowchart of the present invention method attending the periodically timer event.

FIG. 7 is a flowchart of the present invention method attending the network rejection event.

### DETAILED DESCRIPTION OF THE PREFERRED EMBODIMENT

For a better understanding, the terms used herein are briefly defined before going to the detailed description of the invention with reference to the accompanying drawings.

UMTS: stands for Universal Mobile Telecommunication System and means a 3rd generation mobile communication network.

UE/MS: User Equipment/Mobile Station. Means a terminal device.

EPC: stands for Evolved Packet Core and means a core network supportive of a long-term evolution (LTE) net work. An evolved version of UMTS.

EPS: stands for Evolved Packet System and means a mobile communication system including a UE, an access network including LTE, and an EPC.

PDN (Public Data Network): an independent net work in which a service providing server is located.

PDN connection: connection from UE to PDN, i.e., association (connection) between a UE represented with an IP address and a PDN represented with an APN (access point name).

PDN-GW/PGW (Packet Data Network Gateway): a network node of an EPS network performing functions such as UE IP address allocation, packet Screening & filtering, and charging data collection.

Serving GW/SGW (Serving Gateway): a network node of an EPS network performing functions such as mobility anchor, packet routing, idle mode packet buffering, and triggering MME to page UE.

APN (Access Point Name): name of an access point managed by a network, provided from a UE, i.e., a character string for denoting a PDN or distinguishing a PDN from another. Accessing a requested service or network (PDN) gets through a corresponding P-GW, and an APN is a name (e.g., internet.mnc012.mcc345.gprs) pre-defined in the network to be able to discover the P-GW.

NodeB: a UMTS network base station. A NodeB is installed outdoors and corresponds in cell coverage size to a macro cell.

eNodeB: an EPS (Evolved Packet System) base station and is installed outdoors. An eNodeB corresponds in cell coverage size to a macro cell.

eNodeB MME: stands for Mobility Management Entity and plays a role to control each entity in an EPS to provide mobility and session for a UE.

Session: a pathway for data transmission. The unit of session may include PDN, bearer, and IP flow, which respectively correspond the unit of the overall target network (unit of APN or PDN), the unit distinguished by QoS therein (unit of bearer), and unit of destination IP address.

PDN connection: a connection from a UE to a PDN, i.e., an association (connection) between a UE represented with an IP address and a PDN represented with an APN. This means a connection (UE-PDNGW) between entities in a core network to form a session.

UE Context: information on UE's context used to manage UE in network, i.e., context information consisting of UEid, mobility (e.g., current location), and session attribute (QoS, or priority)

OMA DM (Open Mobile Alliance Device Management): a protocol designed for managing mobile devices Such as mobile phones, PDAs, or portable computers and performs functions such as device configuration, firmware upgrade, and error reporting.

OAM (Operation Administration and Maintenance): denotes a group of network management functions displaying network faults and providing capability informa tion, diagnosis and data.

NAS configuration MO (Management Object): MO (Management Object) used to configure in UE parameters associated with NAS functionality

NAS (Non-Access-Stratum): A higher stratum of a control plane between a UE and an MME. The NAS supports mobility management, session management, IP address management, etc., between the UE and the network.

MM (Mobility Management) operation and procedure: An operation or procedure for mobility regulation/management/control of the UE. The MM operation/procedure may be interpreted as including one or more of an MM operation/procedure in a CS network, a GMM operation/procedure in a GPRS network, and an EMM operation/procedure in an EPS network. The UE and the network node (e.g., MME, SGSN, and MSC) exchange an MM message to perform the MM operation/procedure.

SM (Session Management) operation and procedure: An operation or procedure for regulating, managing, processing or handling a user plane and/or a bearer context/PDP context of the UE. The SM operation/procedure may be interpreted as including one or more of an SM operation/procedure in a GPRS network and an ESM operation/procedure in an EPS network. The UE and the network node (e.g., MME and SGSN) exchange an SM message to perform the SM operation/procedure.

The following acronyms are used herein.

3GPP: Third Generation Partnership Project

3GPP2: Third Generation Partnership Project 2.

APN: Access Point Name.

BS: Base Station.

BSC: Base Station Controller.

BTS: Base Transceiver Stations.

CAT: Card Application Toolkit.

CDMA: Code Division Multiple Access.

CPU: Central Processing Unit.

eNB: eNodeB.

EPC: Evolved Packet Core.

eSIM: Embedded SIM.

eUICC: Embedded Universal Integrated Circuit Card.

ETSI: European Telecommunications Standards Institute.

GGSN: Gateway GPRS Support Node.

GPS: Global Positioning System.

GSM: Global System for Mobile Communications.

HLR: Home Location Register.

HSS: Home Subscriber Server.

IMSI: International Mobile Subscriber Identity.

I/O: Input/Output interface.

LTE: Long Term Evolution.

MAP: Mobile Application Part.

MCC: Mobile Country Code.

ME: Mobile Equipment.

MME: Mobility Management Entity.

MNC: Mobile Network Code.

MOQ: Minimum Order Quantity.

NodeB: Base Station in UMTS terminology.

NB: NodeB.

OTA: Over-The-Air.

PDN: Packet Data Network.

PDP: Packet Data Protocol.

PGW: Packet Data Network Gateway.

PLMN: Public Land Mobile Network.

RAM: Random Access Memory.

RAT: Radio Access Technology.

RF: Radio Frequency.

RNC: Radio Network Controller.

ROM: Read Only Memory.

RUIM: Removable User Identity Module defined by 3GPP2.

RX: Reception module on the communication system.

SGSN: Serving GPRS Support Node.

SIM: Subscriber Identity Module.

STK: Sim Toolkit.

TX: Transmission module on the communication system.

UE: User Equipment.

UICC: Universal Integrated Circuit Card.

UIM: User Identity Module.

USB: Universal Serial Bus.

USSD: Unstructured Supplementary Service Data.

UMTS: Universal Mobile Telecommunications System.

VAS: Value Added Services.

Referring now to the drawings, the present invention is generally referred to with numeral 10.

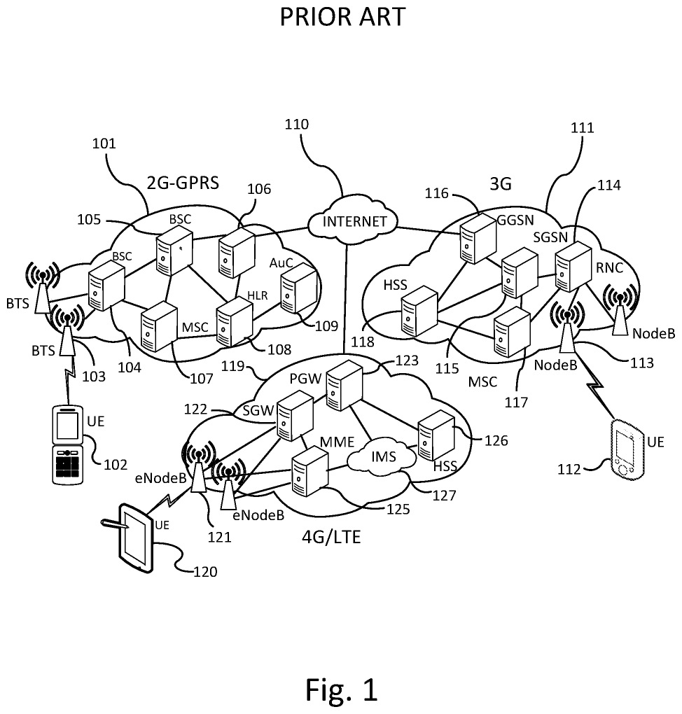

FIG. 1 represents how data connectivity is delivered, like Internet 110, within different network technologies. 2G-GPRS network 101 deploys a Packet Switch Domain as aggregation of the traditional Circuit Switch Domain on 2G pure networks, where services like voice, SMS, USSD are delivered. Circuit Switched Data connection are not part of this diagram as dedicated circuits for data transmission does not use APN profiles being discontinued on the mobile network evolutions.

User Equipment (UE) 102, which is composed by a Mobile Equipment (ME) and a SIM card, get RF connectivity to 2G-GPRS network 101 via Base Transceiver Stations (BTS) 103. Each BTS 103 is connected to main Base Station Controller (BSC) 104 as a main signaling gateway between Access Network and Core Network. Originally with only dedicated circuit switched services (voice, SMS, USSD), the signaling was routed to MSC 107, after the first package switch service requirement BSC 104 signal was split to MSC 107 and Serving GPRS Support Node (SGSN) 105. SGSN 105 receives the Packet Data Protocol (PDP) context activation request and query Home Location Register (HLR) 108 for the list of the subscriber authorizes APN profiles, once validated the right access to data services resolve the destination gateway IP or GGSN 106 in order to route the PDP context.

GGSN 106 serves as link to the data services, like Internet 110 for 2G-GPRS networks 101 and 3G network 111. On 2G-GPRS networks 101, HLR 108 stores the DB of the home subscribers exchanging the authentication process with the AuC 109. In this scheme, AuC 109 executes only way authentication granting the subscriber identity and access to the network.

HLR 108 is used to keep specific subscriber APN information. A list of allowed APNs for each subscriber is stored in HLR 108 records as a part of subscription data. Each time UE 102 tries to access data services via SGSN 105, HLR 108 is consulted and the allowed APN list from the subscriber is copy to SGSN 105 temporary records.

Each APN record points to a dedicated GGSN 106 element as final link to the data services, the internal DNS server convert the APN to the GGSN 106 IP information used for the SGSN 105 to route the data traffic.

The diagram on 3G networks 111 shows changes on the services and topology. Important improvements were deployed oriented to deliver more data throughput and increasing security, the 3G User Equipment (UE) 112 interactions with Access Network via NodeB 113 base station, the BSC element evolved to the RNC 114 adding more capacity to manage the data throughput via SGSN 115 and GGSN 116 that act as link/gateway to the data networks as on 2G-GPRS networks 101.

For 3G 111 network, the original 2G-GPRS HLR 108 and the AuC 109 are merged to a unique element Home Subscriber Server (HSS) 118 including an important security improvement on the authentication subscriber process. Instead of a one way authentication, 3G 111 adopts mutual authentication so that not only the subscriber has to be validated by the network, the network itself has to be validated by the subscriber avoiding fakes BTS 103 trying to recover by brute-forcing hacking methods the sensitive data stored on an Universal Integrated Circuit Card (UICC). A Millenage authentication algorithm is adopted as a default algorithm, increasing security to not get secret algorithm(s) that were compromised on 2G-GPRS 101 with Comp128 algorithms, instead using secret 3GPP adopts strong encryption schemes.

3G 111 APN profile management is kept as in 2G-GPRS 101 for backward compatibilities. HSS 118 stores an allowed APN list, and this required information is shared to SGSN 115.

The evolution to 4G/LTE networks 119 is totally oriented on a Package Switching Domain, in fact all the circuit switched services (voice, SMS, USSD) can be delivered with traditional 3G network 111 infrastructure, and the data services routed to 4G/LTE 119 directly from the multimode UE 120, this capability to separate the voice and data systems bring the 4G/LTE 119 evolution a real unified Radio Access Technology (RAT) enabler as was the common path to unify CDMA2000 networks and UMTS.

On 4G/LTE UE devices 120, the RF interconnection to the network is performed via the evolved E-NodeB 121 (eNB) base station that embeds its own control functionality, rather than using a RNC, which disappears on 4G/LTE networks 119.

The mobility management for 4G/LTE 119 requires that user connectivity across the cellular network shall be maintained at speeds from 120 to 350 km/h, which forced to be performed by a dedicated core network element named Mobility Management Entity (MME) 125.

MME 125 is an element for performing the access of a terminal to a network connection and signaling and control functions for supporting the allocation, tracking, paging, roaming, handover, etc. of network resources. MME 125 controls control plane functions related to subscribers and session management. MME 125 manages numerous eNodeB 121 and performs conventional signaling for selecting a gateway for handover to another 2G-GPRS 101 and 3G 111 networks. Furthermore, MME 125 performs functions, such as security procedures, terminal-to-network session handling, and idle terminal location management. SGSN 115 handles all packet data, such as a user's mobility management and authentication for different access 3GPP networks (e.g., a GPRS network and an UTRAN/GE RAN).

The equivalent elements for data traffic routing are Serving Gateway (SGW) 122 serving as SGSN on 4G/LTE networks 119, and Packet Data Network Gateway (PGW) 123 serving as GGSN on 4G/LTE networks 119. S-GW (SGW) 122 is responsible for managing user data tunnels between eNode-B 121 in the radio network and PDN-GW (PGW) 123, which is the gateway router to the data services, like Internet 110. Tunnel creation and modification are controlled by the MME 125.

In the network configuration, SGW 122 and PGW 123 have been illustrated as being separate gateways, but the two gateways may be implemented in accordance with a single gateway configuration option.

4G/LTE network 119 shares its subscriber database with Global System for Mobile Communications (GSM) and Universal Mobile Telecommunications System (UMTS) using the same element HSS 126. In these systems, the database is referred to as the Home Location Register (HLR) and the Mobile Application Part (MAP) is used as the protocol between MSC 117 and SGSN 115 on the one side, and HLR 108 on the other side. In 4G/LTE 119, an IP-based protocol referred to as “DIAMETER” is used to exchange information with the database.

The concept of PDP context is managed on 4G/LTE network 119 as PDN Connectivity. APN management is one of the unchanged process shares by all the network evolutions. APN profiles are still listed on the HSS 126 as part of each subscriber data and shared to the SGW 122 when initiation a data connection.

Referred as part the 4G/LTE networks 119 evolution, IP Multimedia Subsystem (IMS) 127 is a key enabler of the VAS, a further step toward an all IP wireless network is IMS 127. The groundwork for IMS 127 was laid in 3GPP Release 5. Subsequent versions of the standard have extended it with new functionalities. Instead of using the circuit-switched part of the radio network, the IMS handles voice calls and other services via the packet-switched part of the network bringing the possibility to totally shut down the legacy Circuit Switched Systems, the IMS APN management is totally based on 4G/LTE network 119, delegating the connectivity layer this subsystem.

As final ecosystem, each UE 120 may be configured to communicate using any of a plurality of radio access technologies. The UE may also be referred to simply as “a user device” or “mobile device” or “UE device”. As UE 120 moves geographically from one region to another region, it may need to use different RATs. Thus, the current RAT being used by UE 120 may change from time to time during the mobility process. FIG. 1 shows UE 120 in the vicinity of base station 121, which uses a first RAT 4G/LTE network 119. However, if UE 120 moves into the neighborhood of base station (nodeB) 113, it may need to use a different RAT as 3G network 111, and so on.

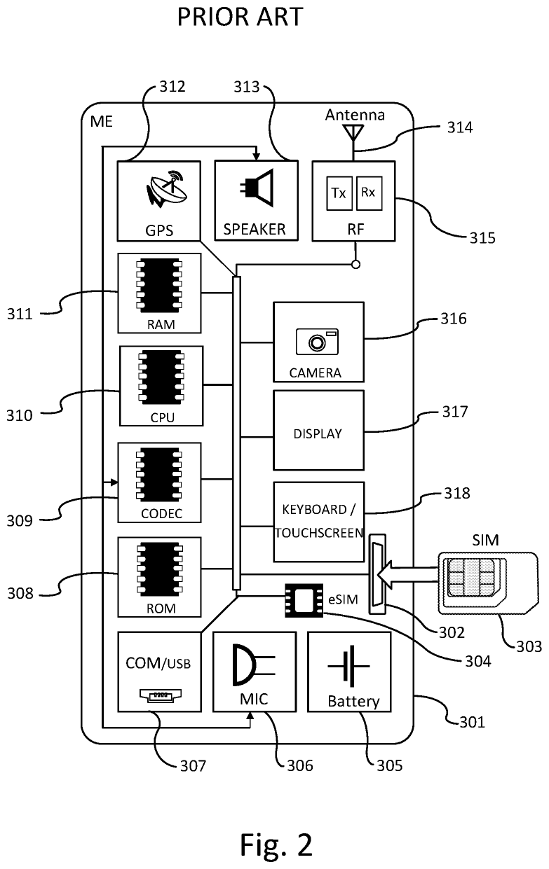

Seen in FIG. 2 is a prior art block diagram of an exemplary User Equipment (UE) 301 in which present invention 10 may be implemented. While various components of UE 301 are depicted, various embodiments of UE 301 may include a subset of the listed components or additional components not listed.

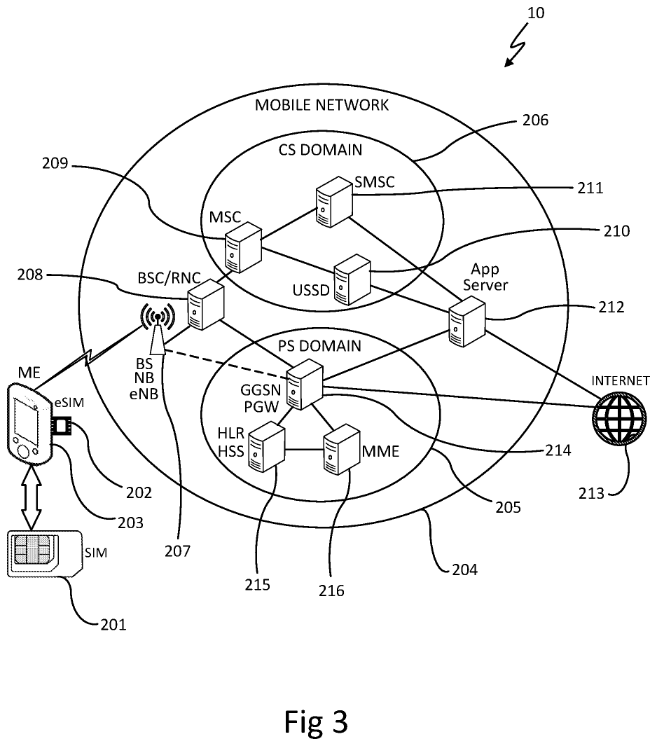

UE 301 may take various forms including a wireless handset, a personal digital assistant (PDA), a portable computer, a tablet computer, or a laptop computer. Many suitable devices combine some or all of these functions. In some embodiments, UE 301 is not a general purpose computing device like a portable, laptop or tablet computer, but rather is a special-purpose communications device such as a mobile phone, a wireless handset, a PDA, or a telecommunications device installed in a vehicle. UE 203, seen in FIG. 3, may likewise be a device, include a device, or be included in a device that has similar capabilities, but that is not transportable, such as a desktop computer, a set-top box, or a network node.

For that function, UE 301 includes microphone 306 for audio signal input, and speaker 313 for audio signal output. Microphone 306 and speaker 313 connect to voice coding and decoding circuitry (Codec) 309. For a voice telephone call, for example, Codec 309 provides two-way conversion between analog audio signals representing speech or other audio and digital samples at a compressed bit rate compatible with the digital protocol of wireless telephone network communication or voice over packet (Internet protocol) communications.

UE 301 comprises memory ram 311 and memory rom 308. UE 301 may further comprises antenna 314, radio frequency (RF) transceiver 315 with respective Transmission Tx and reception Rx subsystems, battery 305, microphone 306, speaker 313, headset port 1116, an communication port input/output (I/O) with universal serial bus (USB) interface 307, a short range wireless communication Sub-system 1124, keyboard 318, display 317, which may include a touch sensitive surface, charge coupled device (CCD) camera 316, and a global positioning system (GPS) sensor 312. In various embodiments, the UE 301 may include another kind of display that does not provide a touch sensitive screen. In an embodiment, the CPU 310 may communicate directly with the memory RAM 311 or ROM 308 without passing through the communication port 307. In various embodiments, CPU 310, or some other form of controller or central processing unit (CPU) 310, operates to control the various components of UE 301 in accordance with embedded software or firmware stored in ROM memory 308. CPU 310 may execute other applications stored in the memory RAM 311 or ROM 308 or made available via information carrier media such as portable data storage media like the removable memory card or via wired or wireless network communications. The application software may comprise a compiled set of machine-readable instructions that configure CPU 310 to provide the desired functionality, or the application software may be high-level software instructions to be processed by an interpreter or compiler to indirectly configure CPU 310. Antenna 314 may be provided to convert between wireless signals and electrical signals, enabling UE 301 to send and receive information from a cellular network or some other available wireless communications network or from a peer UE 301.

In an embodiment, antenna 314 may include multiple antennas to Support beam forming and/or multiple input multiple output (MIMO) operations. The keyboard types are a traditional numeric keypad with alphabet letters associated with a telephone keypad. The input keys may likewise include a track wheel, an exit or escape key, a trackball, and other navigational or functional keys, which may be inwardly depressed to provide further input function.

UE 301 may likewise present options for a user to select, controls for the user to actuate, and cursors or other indicators for the user to direct. UE 301 may further accept data entry from the user, including numbers to dial or various parameter values for configuring the operation of the UE 301. UE 301 may further execute one or more software or firmware applications in response to user commands. These applications may configure UE 301 to perform various customized functions in response to user interaction. Additionally, UE 301 may be programmed or configured over-the-air (OTA).

UE 301 may include a UICC 303 inside the mobile station UE 301 via communication interface 302 and Input/Output (I/O) port of the UICC 303. The various components may include mobile client applications such as an Open Mobile Alliance-Device Management (OMA-DM) client, etc. running on CPU 310 in the mobile station UE 301. UICCs 303 are standardized, although they may be provided in different form factors. UICCs 303 may also be implemented in different manners such as removable cards, or embedded in a device 304 (e.g., being soldered onto the Printed Circuit Board (PCB) of the device).

FIG. 3 illustrates a high level, conceptual diagram of present invention 10, showing wireless communication between user equipment (UE) 203, mobile network 204, and application server 212, and examples of event message communications between user equipment (UE) 203, and Universal Integrated Circuit Card (UICC) 201 residing in UE 203. In some embodiments, UE 203 may have eSIM/eUICC 202 embedded onboard. Although in the examples below, event messages are generated and sent to SIM/UICC 201 residing in UE 203.

A plurality of UEs 203 wirelessly communicate with a plurality of base stations 207. Base stations 207 may couple to a network 2G-GPRS 101 or 3G 111 or 4G/LTE 119. Base stations 207 may be partitioned into subsets based on the type of radio access technology (RAT) or wireless communication standard they are configured to use for communicating with UEs 203. For example, a first subset of base stations 207 may use a first RAT for communicating with UEs 203. A second Subset of the base stations 207 may use a second RAT to communicate with UEs 203, and so on. The total number of UEs 203 and the number of UEs 203 per base station 207 are not meant to be limiting. The RATs used by the subsets of base stations 207 may include RATs conforming to GSM, CDMA, GPRS, W-CDMA, EDGE, HRPD CDMA2000, LTE, WiMAX, WiFi, Bluetooth, etc.

In this embodiment, FIG. 3 shows network segmentation by Domains. The Two main domains regarding commutation are defined as: Package Switching Domain (PS Domain) 205 and Circuit Switching Domain (CS Domain) 206. The main difference is based on the type of resource to switch. Circuit Switching Domain (CS Domain) 206 dedicates resources as “circuit”, this requires a point-to-point circuit granted during the time of the communication. Package Switching Domain (PS Domain) 205 grants the resources as a “package” that minimizes an impact on the whole network structure. Clearly the tendencies on network communication are evolving to manage the complete network resources administration to Package Switching.

In certain embodiments, Base Station (BS, NB, eNB) 207 routes the Circuit base services like Voice calls, SMS, USSD to BSC/RNC 208, wherein BSC is on 2G-GPRS 101 networks, and RNC is on UMTS networks. In others embodiments, the Package based services are routed directly to the PS Domain 205 directly from the Base Station (BS, NB, eNB) 207.

In certain embodiments, CS Domain 206 has MSC 209 as a main routing element that transfers the service to a dedicated subsystem. In the case of SMS, the destination system is SMSC 211. In the case of USSD services, the destination is Gateway USSD 210. Both subsystems SMSC 211 and USSD 210 are connected to Application Server 212.

FIG. 3 also shows certain embodiments as PS Domain 205 serving the packages services, based on the radio access technology (RAT), PS Domain 205 receives the signaling to SGSN/GGSN 214 element on 2G-GPRS 101, 3G 110, and 4G/LTE 119 networks. The entry point of the PS Domain 205 is the SGW/PGW 214 connected to HLR HSS 215 and MME 216.

Message implementations are illustrated in a context of UE 203 connecting to a data network or PS Domain 205. SIM 201 or the eSIM 202 have an application running as main process monitor. In some embodiments, the SIM application is a JavaCard interoperable applet, in others embodiments the application is native to the Smart Card Operative System (SCOS).

The monitoring application resident on SIM 201 evaluates data connectivity to Application Server 212 by submitting periodically a STK proactive command OPEN_CHANNEL with specific parameters to immediately link a setup with Default (network) Bearer, which explicitly requests a terminal UE for providing the parameters necessary to establish a connection as the APN, the default predefined on UE 203. As result of this STK request, UE 203 must respond with a TERMINAL_REPONSE parameter, which informs if the command was successfully executed or not. Upon detected errors of the STK command, the application resident on the SIM will again request the command OPEN_CHANNEL but also explicitly include the APN that shall be configured on UE 203. After this dual validation, the SIM will conclude upon success of the second STK command that UE 203 does not have properly configured the default APN.

The information about the APN profile or the connection parameters details like IP address of the Application server 212 or the period interval are stored on the SIM/eSIM 202. In certain embodiments this information is updated by an OTA platform, in other embodiments the applet configuration is done at SIM 201 production process.

The communication link from UE 203 and the Application servers 212 can be setup in several ways depending on the Mobile operator strategy or policy, in some deployments the service SMS is used transferring the elements of the monitoring via the CS Domain 206, in others embodiments the alert or information is transferred via the USSD 210 service to the destination Application server.

As example of one embodiment, the information of the monitoring process is transferred via the PS Domain 205 if the second OPEN_CHANNEL command is successfully executed.

In certain embodiments, Application server 212 has access to public internet 213 offering the possibility to interact with third parties, as handset manufacturer web services or exposed solutions, for the correct APN setup like OTA platforms, OMA DM platforms, etc.

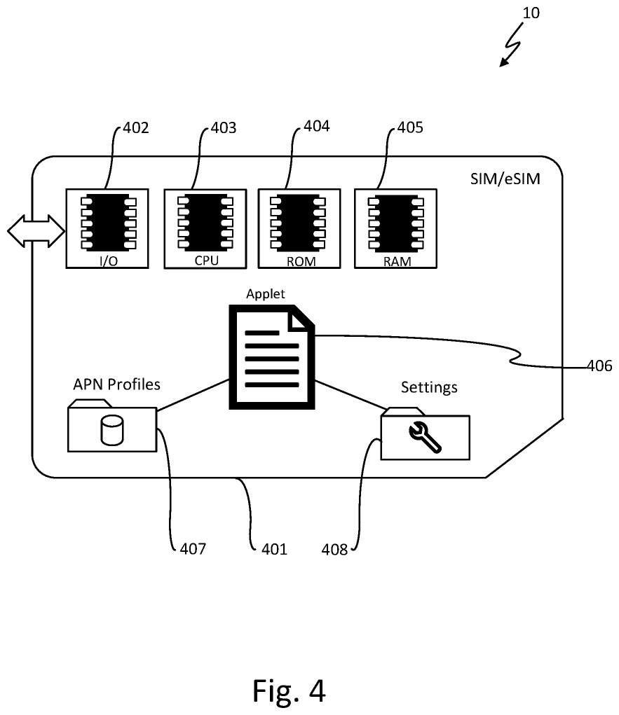

Seen in FIG. 4 is UICC 401 of present invention 10. UICC 401 comprises a processor or microprocessor 403, its own data storage such as ROM 404, RAM 405, and I/O circuit 402. RAM 405 is a Random Access Memory (RAM) or a Static Random Access Memory (SRAM) for data processing. ROM 404 is a non-volatile memory of the Read Only Memory (ROM) type or of the flash type, and it may include the operating system of UICC 401. Memory may be a non-volatile memory, such as ROM 404 or an Electrically Erasable Programmable Read Only Memory (EEPROM) or a flash memory, for storing algorithms, keys, and credentials of the subscriber or user of the UE.

I/O port 402 is an interface for exchanging messages with the user device portion of the mobile station including the baseband processor or module or microprocessor 403. That is, the UICC 401 sends and receives messages via I/O port 402 and communication interfaces.

One role performed by UICC 401 in a mobile station is to authenticate the validity of the mobile station to a network when accessing the network, and in so doing, providing the integrity and security of Subscriber's personal data. Depending on the type or types of mobile communication networks that the mobile station can access, UICC 401 may run one or more applications such as Subscriber Identity (SIM), CDMA Subscriber Identity Module (CSIM), IP Multimedia Services Identity Module (ISIM), and Universal Subscriber Identity Module (USIM) applications. It may contain at least one of SIM, CSIM, and USIM applications for accessing a mobile network in accordance with different technology adopted by a carrier. For example, in a GSM network, the UICC runs a SIM application; in a CDMA network, UICC 401 runs a CSIM application; in a 3G or UMTS network, UICC 401 runs a USIM application. In a LTE network, the UICC 401 may run a USIM or its variant application and/or an ISIM application. The ISIM application provides the mobile station access to the IP multimedia Subsystem (IMS) via any IP access network, by providing a set of IMS security data and performing functions for IMS access, such as mutual authenticating and provisioning for IMS-based services. UICC 401 may also store applications for both carrier and subscriber use. For example, UICC 401 may contain Subscriber credentials, network and service configuration data, services application programs such as roaming, branding, etc. Being removable, UICC 401 makes it possible to easily transfer subscriber information from device to device, enabling seamless management of Subscriber information exchange, such as transferring contacts and preferences from one device to another, while providing secure access to the network. Further, once UICC 401 has been authenticated and activated, it can be remotely managed via Over-the-Air. Further, UICCs 401 provide many benefits to a carrier as well as subscribers, including portability, security, trust, etc.

Present invention 10, comprising UICC 401, has resident Applet 406 that monitors periodically the data connection parameters default APN. Applet 406 can be run over a JavaCard Virtual Machine in the case of JavaCard SCOS, or native application on native SCOS.

In a preferred embodiment, Applet 406 stores on non-volatile memory the parameters and settings related Applet 406 behavior. Part of these parameters are the APN profiles 407 and connectivity details or settings 408 for both scenarios, default APN test and preconfigured APN with the PDN where the Application Server can be reach. As part of this embodiment example can be configured the time interval between monitor events, error codes that are associated to the missing or broken APN default, etc.

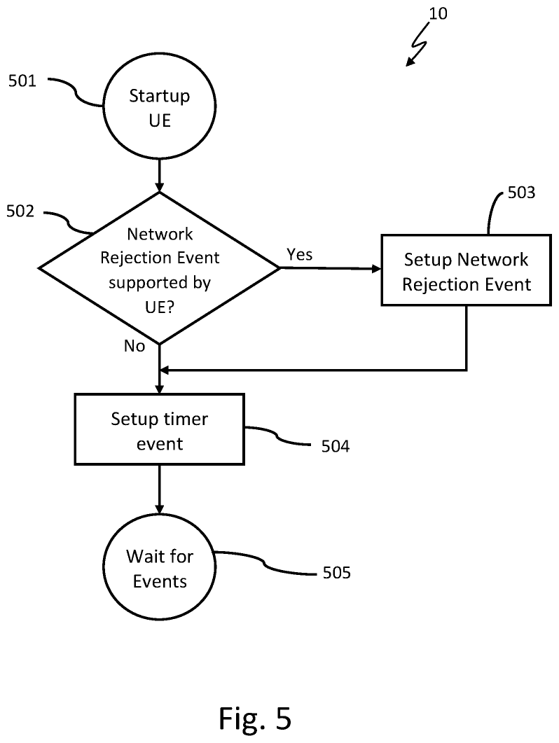

FIG. 5 is a flowchart of the present invention method during a startup communication between the Mobile Equipment (ME) and the subscriber identity module (SIM/eSIM). Specifically, present invention 10 comprises the following steps:

Step 501—Starting up a User Equipment, whereby a Mobile Equipment executes a start up process and said Mobile Equipment starts a communication exchange with a SIM/eSIM;

Step 502—Evaluating a Network Rejection Event supported by said User Equipment, whereby said SIM/eSIM evaluates a TERMINAL_PROFILE capability of said Mobile Equipment in order to detect if said User Equipment supports said Network Rejection Event;

Step 503—Setting up said Network Rejection Event, whereby if an answer is yes, said SIM/eSIM sends to said Mobile Equipment a first setup of said Network Rejection Event;

Step 504—Setting up a timer event, whereby if said answer is no, said SIM/eSIM sends to said Mobile Equipment a second setup of a Timer using a defined T period; and

Step 505—Waiting for events, whereby said SIM/eSIM waits for an occurrence of either said Network Rejection Event or a TIMER_EXPIRATION.

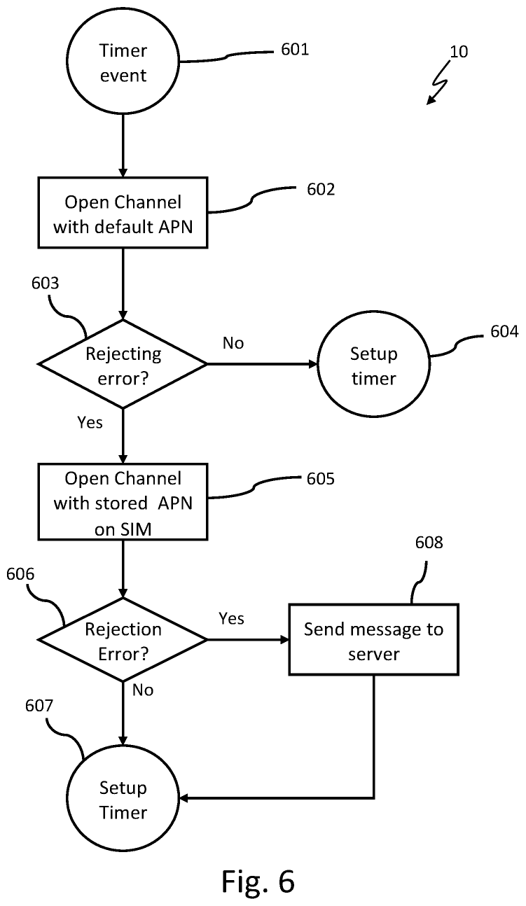

FIG. 6 is a flowchart of the present invention method attending a periodically timer event. Specifically, present invention 10 comprises the following steps:

Step 601—Having said timer event, said Mobile Equipment sends to said SIM/eSIM a proactive command ENVELOPE_TIMER_EXPIRATION;

Step 602—Opening a channel with a default APN, whereby said SIM/eSIM sends to said Mobile Equipment an OPEN_CHANNEL data connection using parameters defined as DEFAULT_APN;

Step 603—Evaluating a Rejecting error, whereby said Mobile Equipment sends to said SIM/eSIM a result of said OPEN_CHANNEL data connection using said parameters defined as said DEFAULT_APN, and said SIM/eSIM evaluates if there is said Rejecting error;

Step 604—Setting up said Timer if said answer is no, whereby after a successful said OPEN_CHANNEL data connection with said DEFAULT_APN, said SIM/eSIM requests to said Mobile Device to setup the TIMER with the defined T period;

Step 605—Opening said channel with a stored said default APN on said SIM/eSIM if said answer is yes, whereby after an error is received as a result of said OPEN_CHANNEL data connection with said default APN, said SIM/eSIM sends to said Mobile Equipment said OPEN_CHANNEL data connection using said parameters defined as a APN_SERVICE;

Step 606—Evaluating said Rejecting error, whereby said Mobile Equipment sends to said SIM/eSIM said result of said OPEN_CHANNEL data connection using said parameters defined by said APN_SERVICE, and said SIM/eSIM evaluates if there is an error;

Step 607—Setting up said timer if said answer is no, whereby after a successful said OPEN_CHANNEL data connection with said APN_SERVICE; and

Step 608—Sending a message to said management server if said answer is yes, whereby after an error is received as a result of said OPEN_CHANNEL data connection with said DEFAULT_APN, said SIM/eSIM detects that said Mobile Equipment has a faulty said DEFAULT_APN and initiates a process to inform a management server in order to take action to set up correctly said APN_SERVICE on said Mobile Device.

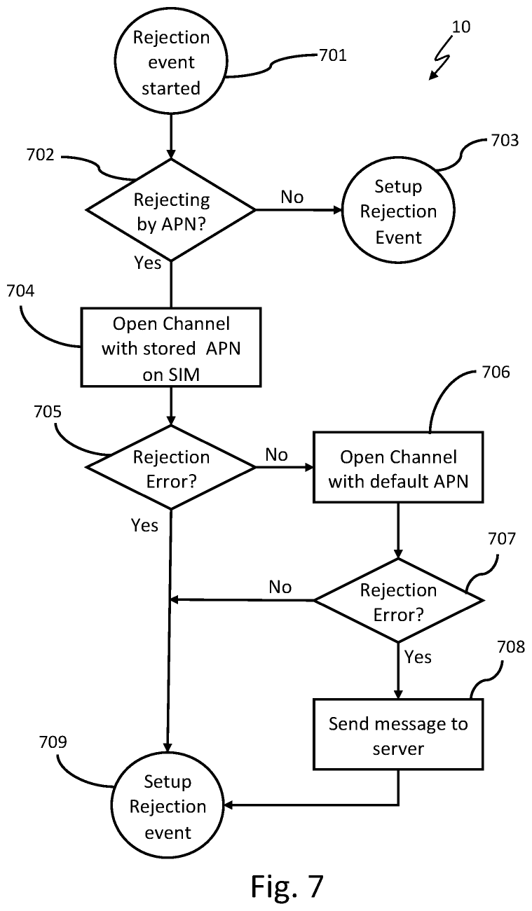

FIG. 7 is a flowchart of the present invention method attending the network rejection event. Specifically, present invention 10 comprises the following steps:

Step 701—Having said rejection event initated, said Mobile Equipment sends said SIM/eSIM a proactive command REJECTION_NETWORK with REJECTION code information, said SIM/eSIM disables said Network Rejection Event in order to avoid re-entrance during said rejection event;

Step 702—Evaluating said Network Rejection Event, whereby said SIM/eSIM determines if said REJECTION code information is related to said OPEN_CHANNEL data connection in order to test an OPEN_CHANNEL procedure with and without said DEFAULT_APN;

Step 703—Setting up said Network Rejection Event if said answer is no, whereby said SIM/eSIM sets up again said Network Rejection Event to said Mobile Equipment;

Step 704—Opening said OPEN_CHANNEL data connection with a stored said APN_SERVICE on said SIM/eSIM if said answer is no, whereby said SIM/eSIM sends to said Mobile Equipment said OPEN_CHANNEL data connection using said parameters defined as said APN_SERVICE;

Step 705—Evaluating said Rejecting error, whereby said Mobile Equipment sends to said SIM/eSIM a result of said OPEN_CHANNEL data connection using said parameters defined as said APN_SERVICE, and said SIM/eSIM evaluates if there is an error;

Step 706—Opening said OPEN_CHANNEL data connection with said DEFAULT_APN if said answer is no, whereby after a successful result of said OPEN_CHANNEL with an APN_SERVICE, said SIM/eSIM sends to said Mobile Equipment said OPEN_CHANNEL data connection using said parameters defined as said DEFAULT_APN;

Step 707—Evaluating said Network Rejection Event, whereby after an error of said OPEN_CHANNEL data connection with said DEFAULT_APN said SIM/eSIM detects said Mobile Equipment having a faulty said DEFAULT_APN and initiates a process to inform said management server in order to take action to setup correctly said APN_SERVICE on said Mobile Device, and whereby if said answer is no, said SIM/eSIM sets up again said Network Rejection Event;

Step 708—Sending a message to said management server if said answer is no, whereby said SIM/eSIM sets up again said REJECTION_NETWORK event to said Mobile Device; and

Step 709—Setting up said Network Rejection Event, whereby said SIM/eSIM sets up again said REJECTION_NETWORK event to said Mobile Device.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. System and method for monitoring mobile data configuration access point names, comprising the steps of:
A) triggering a packet data protocol context activation procedure or Public Data Network connectivity procedure in response to receiving, from a universal integrated circuit card, an Open Channel command with parameters that request a user equipment using a default APN;
B) receiving by said user equipment a terminal response evaluating received information and detecting an ACTIVATE packet data protocol CONTEXT REJECTION or Public Data Network CONNECTIVITY REJECTION message including a session management cause; and
C) triggering said packet data protocol context activation procedure or said Public Data Network connectivity procedure in response to receiving from said universal integrated circuit card, said Open Channel command with said parameters including specific APN profile.

2. The system and method for monitoring mobile data configuration access point names set forth in claim 1, further characterized in that said universal integrated circuit card monitors rejections related to data connection errors, and selects via an Open Channel command an APN profile that sets up as default on said user equipment, and said universal integrated circuit card monitors a result of said rejections related data connection errors.

3. The system and method for monitoring mobile data configuration access point names set forth in claim 2, further characterized in that said terminal response is used to indicate to said universal integrated circuit card that there has been a problem with said Open Channel command.

4. The system and method for monitoring mobile data configuration access point names set forth in claim 2, further characterized in that an Application server receives monitoring notifications including rejections related data connection errors.

5. System and method for monitoring mobile data configuration access point names, comprising the steps of:
A) Starting up a User Equipment, whereby a Mobile Equipment executes a start up process and said Mobile Equipment starts a communication exchange with a SIM/eSIM;
B) Evaluating a Network Rejection Event supported by said User Equipment, whereby said SIM/eSIM evaluates a TERMINAL_PROFILE capability of said Mobile Equipment in order to detect if said User Equipment supports said Network Rejection Event;
C) Setting up said Network Rejection Event, whereby if an answer is yes, said SIM/eSIM sends to said Mobile Equipment a first setup of said Network Rejection Event;
D) Setting up a timer event, whereby if said answer is no, said SIM/eSIM sends to said Mobile Equipment a second setup of a Timer using a defined T period; and
E) Waiting for events, whereby said SIM/eSIM waits for an occurrence of either said Network Rejection Event or a TIMER_EXPIRATION.

6. The system and method for monitoring mobile data configuration access point names set forth in claim 5, further comprising the steps of:
F) Having said timer event, said Mobile Equipment sends to said SIM/eSIM a proactive command ENVELOPE_TIMER_EXPIRATION;
G) Opening a channel with a default APN, whereby said SIM/eSIM sends to said Mobile Equipment an OPEN_CHANNEL data connection using parameters defined as DEFAULT_APN;
H) Evaluating a Rejecting error, whereby said Mobile Equipment sends to said SIM/eSIM a result of said OPEN_CHANNEL data connection using said parameters defined as said DEFAULT_APN, and said SIM/eSIM evaluates if there is said Rejecting error;
I) Setting up said Timer if said answer is no, whereby after a successful said OPEN_CHANNEL data connection with said DEFAULT_APN, said SIM/eSIM requests to said Mobile Device to setup the TIMER with the defined T period;
J) Opening said channel with a stored said default APN on said SIM/eSIM if said answer is yes, whereby after an error is received as a result of said OPEN_CHANNEL data connection with said default APN, said SIM/eSIM sends to said Mobile Equipment said OPEN_CHANNEL data connection using said parameters defined as a APN_SERVICE;
K) Evaluating said Rejecting error, whereby said Mobile Equipment sends to said SIM/eSIM said result of said OPEN_CHANNEL data connection using said parameters defined by said APN_SERVICE, and said SIM/eSIM evaluates if there is an error;
L) Setting up said timer if said answer is no, whereby after a successful said OPEN_CHANNEL data connection with said APN_SERVICE; and
M) Sending a message to said management server if said answer is yes, whereby after an error is received as a result of said OPEN_CHANNEL data connection with said DEFAULT_APN, said SIM/eSIM detects that said Mobile Equipment has a faulty said DEFAULT_APN and initiates a process to inform a management server in order to take action to set up correctly said APN_SERVICE on said Mobile Device.

7. The system and method for monitoring mobile data configuration access point names set forth in claim 5, further comprising the steps of:
F) Having said rejection event initated, said Mobile Equipment sends said SIM/eSIM a proactive command REJECTION_NETWORK with REJECTION code information, said SIM/eSIM disables said Network Rejection Event in order to avoid re-entrance during said rejection event;
G) Evaluating said Network Rejection Event, whereby said SIM/eSIM determines if said REJECTION code information is related to said OPEN_CHANNEL data connection in order to test an OPEN_CHANNEL procedure with and without said DEFAULT_APN;
H) Setting up said Network Rejection Event if said answer is no, whereby said SIM/eSIM sets up again said Network Rejection Event to said Mobile Equipment;
I) Opening said OPEN_CHANNEL data connection with a stored said APN_SERVICE on said SIM/eSIM if said answer is no, whereby said SIM/eSIM sends to said Mobile Equipment said OPEN_CHANNEL data connection using said parameters defined as said APN_SERVICE;
J) Evaluating said Rejecting error, whereby said Mobile Equipment sends to said SIM/eSIM a result of said OPEN_CHANNEL data connection using said parameters defined as said APN_SERVICE, and said SIM/eSIM evaluates if there is an error;
K) Opening said OPEN_CHANNEL data connection with said DEFAULT_APN if said answer is no, whereby after a successful result of said OPEN_CHANNEL with an APN_SERVICE, said SIM/eSIM sends to said Mobile Equipment said OPEN_CHANNEL data connection using said parameters defined as said DEFAULT_APN;
L) Evaluating said Network Rejection Event, whereby after an error of said OPEN CHANNEL data connection with said DEFAULT_APN said SIM/eSIM detects said Mobile Equipment having a faulty said DEFAULT_APN and initiates a process to inform said management server in order to take action to setup correctly said APN_SERVICE on said Mobile Device, and whereby if said answer is no, said SIM/eSIM sets up again said Network Rejection Event;
M) Sending a message to said management server if said answer is no, whereby said SIM/eSIM sets up again said REJECTION_NETWORK event to said Mobile Device; and
N) Setting up said Network Rejection Event, whereby said SIM/eSIM sets up again said REJECTION_NETWORK event to said Mobile Device.
